(19) United States
(12) Patent Application Publication
(10) Pub. No.: US 2026/0338955 A1
(43) Pub. Date: Oct. 29, 2026

(54) METHOD AND APPARATUS FOR IDENTIFYING CHARGING BASE STATION, ROBOT, AND COMPUTER PROGRAM PRODUCT

(71) Applicants: Best Epoch Technology Co., Ltd., Shenzhen (CN); UBTECH ROBOTICS CORP LTD., Shenzhen (CN)

(72) Inventors: PENGFEI WU, Shenzhen (CN); Xiangbin Huang, Shenzhen (CN)

(21) Appl. No.: 19/638,178

(22) Filed: Apr. 3, 2026

(30) Foreign Application Priority Data
Apr. 23, 2025 (CN) 202510517759.5

(51) Int. Cl. G01S 17/89; A47L 11/24; A47L 11/40

(52) U.S. Cl. CPC G01S 17/89; A47L 11/24; A47L 11/4011; A47L 11/4091; A47L 2201/022

(57) ABSTRACT

The present disclosure is applicable to the field of robot technology and provides a method and apparatus for identifying a charging base station, a robot, and a computer program product. The method includes: acquiring point cloud data of a surrounding environment; filtering, from the point cloud data, points having intensity values within a preset intensity range to obtain a first point cloud subset; filtering, from the first point cloud subset, points having angles within a first preset angle range and distances within a first preset distance range to obtain a second point cloud subset; and determining a charging base station identification result based on the second point cloud subset. The present disclosure improves accuracy of identifying the charging base station.

### CROSS REFERENCE TO RELATED APPLICATIONS

The present disclosure claims the benefit of priority under the Paris Convention to Chinese Patent Application 202510517759.5, filed on Apr. 23, 2025, which is incorporated herein by reference in its entirety.

### TECHNICAL FIELD

The present disclosure generally relates to the field of robot technology, and more particularly, to a method and apparatus for identifying a charging base station, a robot, and a computer program product.

### BACKGROUND

A robot (e.g., a sweeping robot) requires aligning with a charging base station paired with the robot during charging. In the alignment process, an infrared receiver on the robot first receives an infrared signal emitted by an infrared transmitter on the charging base station, thereby guiding the robot to move to a position closer to the charging base station. Subsequently, the robot utilizes LiDAR to identify data associated with the charging base station, thereby achieving the function of aligning with the charging base station for charging. However, how to improve accuracy of identifying the charging base station is an urgent technical problem to be solved.

### BRIEF DESCRIPTION OF DRAWINGS

To further clarify the technical solutions in the embodiments of the present disclosure, the following provides a brief introduction to the accompanying drawings referenced in the description of the embodiments or existing technologies. It is evident that the accompanying drawings described below are merely some embodiments of the present disclosure, and those skilled in the art can derive additional drawings based on these accompanying drawings without creative effort.

FIG. 1 is a schematic flowchart of a method for identifying a charging base station according to an embodiment of the present disclosure.

FIG. 2 is an example diagram of three first regions and two second regions arranged on a charging base station according to an embodiment of the present disclosure.

FIG. 3 is an example diagram of a first point cloud subset according to an embodiment of the present disclosure.

FIG. 4 is an example diagram of excluding a target point from the first point cloud subset according to an embodiment of the present disclosure.

FIG. 5 is an example diagram of a first preset angle range and a first preset distance range according to an embodiment of the present disclosure.

FIG. 6 is a clustering example diagram according to an embodiment of the present disclosure.

FIG. 7 is an example diagram of excluding clusters with smaller point numbers and clusters with larger point numbers according to an embodiment of the present disclosure.

FIG. 8 is an example diagram of a second cluster according to an embodiment of the present disclosure.

FIG. 9 is an example diagram of three third clusters according to an embodiment of the present disclosure.

FIG. 10 is a schematic structural diagram of an apparatus for identifying a charging base station according to an embodiment of the present disclosure.

FIG. 11 is a schematic structural diagram of a robot according to an embodiment of the present disclosure.

### DETAILED DESCRIPTION

For the purpose of illustration and not limitation, specific details such as particular system structures and technologies are provided to facilitate a thorough understanding of the embodiments of the present disclosure. However, those skilled in the art should appreciate that the present disclosure can be implemented in other embodiments without these specific details. In other cases, detailed descriptions of well-known systems, devices, circuits, and methods are omitted to avoid unnecessary details that may obscure the description of the present disclosure.

It should be understood that when the term “comprising/including” is used in the description and the appended claims of the present disclosure, it indicates the presence of the described features, elements, steps, operations, and/or components, but does not exclude the presence or addition of one or more other features, elements, steps, operations, components, and/or combinations thereof.

It should also be understood that the term “and/or” as used in the description and the appended claims of the present disclosure refers to any combination or all possible combinations of one or more of the items listed in association and includes these combinations.

As used in the description and the appended claims of the present disclosure, the term “if” may be interpreted contextually as “when,” “once,” “in response to determining,” or “in response to detecting.” Similarly, the phrases “if determined” or “if detected ‘the described condition or event’” may be interpreted contextually to mean “once determined,” “in response to determining,” “once detected ‘the described condition or event’,” or “in response to detecting ‘the described condition or event’.”

Additionally, in the description and the appended claims of the present disclosure, terms such as “first,” “second,” “third,” etc., are used only for distinguishing purposes and should not be interpreted as indicating or implying relative importance.

References to “one embodiment” or “some embodiments” in the description of the present disclosure mean that a specific feature, structure, or characteristic described in connection with one or more embodiments is included in the one or more embodiments of the present disclosure. Thus, the statements appearing in different portions of the description such as “in one embodiment,” “in some embodiments,” “in other embodiments,” and “in additional embodiments” do not necessarily refer to the same embodiment, but rather mean “one or more but not all embodiments,” unless otherwise specifically indicated. The terms “comprises,” “includes,” “has,” and their variations mean “including but not limited to,” unless otherwise specifically indicated.

A method for identifying a charging base station provided in an embodiment of the present disclosure may be applied at mobile and autonomously recharging robots such as sweeping robots, window-cleaning robots, and lawn-mowing robots, without any limitation on the specific type of the robot.

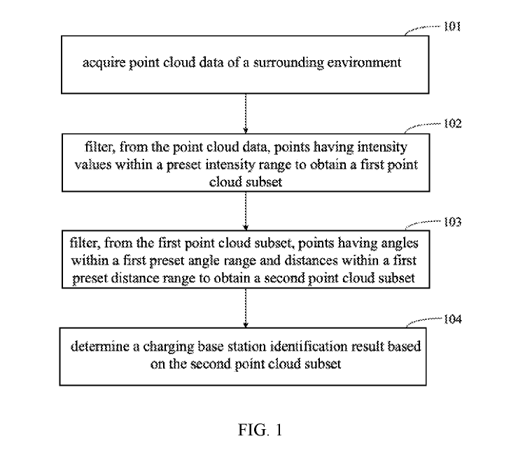

Refering to FIG. 1, FIG. 1 illustrates a schematic flowchart of a method for identifying a charging base station according to an embodiment of the present disclosure. As an example and not a limitation, the method may be applied at a robot and includes the following operations.

At operation 101, point cloud data of a surrounding environment is acquired. The robot may scan the surrounding environment using sensors (e.g., LiDAR) to obtain the point cloud data of the surrounding environment.

The surrounding environment includes a charging base station. In addition to the charging base station, the surrounding environment may further include other objects. Therefore, this embodiment excludes (i.e., filters out) point cloud data of other objects from the point cloud data of the surrounding environment by filtering the point cloud data of the surrounding environment, thereby improving the accuracy of identifying the charging base station.

During the process of returning to the charging base station for charging, an infrared receiver on the robot first needs to receive an infrared signal from an infrared transmitter on the charging base station, thereby guiding the robot to move to a position closer to the charging base station. Then, the robot uses LiDAR to accurately identify data associated with the charging base station, thereby completing the function of aligning with the charging base station for charging. In one embodiment, the robot acquires point cloud data of the surrounding environment in real-time during the process of aligning with the charging base station for charging, so as to filter out data associated with the charging base station from the point cloud data of the surrounding environment. Based on the data associated with the charging base station, the identification of the charging base station is achieved, which not only improves the utilization of LiDAR but also enhances the efficiency of the robot’s identification of the charging base station. The alignment of the robot with the charging base station for charging refers to that the robot precisely adjust its position before charging to align with a position of the charging base station, so as to ensure that charging electrodes of the robot align with charging electrodes of the charging base station.

Taking the sweeping robot as an example, in the process of returning to the charging base station for charging after completing a cleaning task, the sweeping robot needs to locate the charging base station to execute a docking action, and ultimately moves onto the charging base station and makes contact with the charging electrodes of the charging base station to initiate charging. This embodiment allows the sweeping robot to acquire point cloud data of the surrounding environment in real-time during the alignment with the charging base station, enabling the filtering of data assocated with the charging base station from the point cloud data of the surrounding environment, thereby identifying the charging base station that matches the sweeping robot.

The charging base station is configured with N first regions and N-1 second region(s), where N is an integer greater than 1. A first intensity value corresponding to a first region is greater than a second intensity value corresponding to a second region. One second region is arranged between two adjacent first regions. This structural design of the charging base station significantly reduces structural and hardware costs compared to methods of identifying the charging base station using infrared signals, while also allowing for more efficient utilization of point cloud data and more accurate identification of the charging base station’s position, thereby enabling the automatic alignment and charging functionality of the robot.

The first regions may refer to regions on the charging base station that reflect LiDAR signals strongly, meaning that the intensity values of the point cloud data reflected back from the first regions are relatively high. These regions may be understood as high-reflectivity regions, and the point cloud data from the first regions belongs to high-reflectivity data (i.e., point cloud data with a higher intensity value). The second regions may refer to regions on the charging base station that absorb LiDAR signals strongly, meaning that the intensity values of the point cloud data reflected back from the second regions are relatively low. These regions may be understood as wave-absorbing regions, and the point cloud data from the second regions does not belong to high-reflectivity data.

The first intensity value corresponding to the first regions may refer to intensity values of the point cloud data from the first regions, where intensity values of points within each first region are typically the same and equal to the first intensity value. The second intensity value corresponding to the second region may refer to intensity values of the point cloud data from the second region. Since the intensity values of the point cloud data from the second region are typically unstable and numerous, a maximum value of the intensity values of the point cloud data from the second region may be determined as the second intensity value.

Optionally, the first intensity value and the second intensity value may be determined based on empirical values from practical scenarios. As an example and not a limitation, in a practical scenario, positions of the first region and the second region on the charging base station are known. By scanning the first region and the second region with LiDAR, the first intensity value and the second intensity value are obtained. After obtaining the first intensity value and the second intensity value, a preset intensity range used in operation 102 is thus obtained. It should be understood that the preset intensity range may also be determined solely based on the first intensity value that is obtained by scanning the first region with LiDAR. For example, an intensity value that is less than and relatively close to the first intensity value may be determined as a minimum value of the preset intensity range.

As an example and not a limitation, a range of intensity values of the point cloud data may be from 0 to 255, with different values representing different intensity values. If the first intensity value obtained from LiDAR scanning is 255 and the second intensity value is less than 100, the preset intensity range may be set from 250 to 255, allowing for the filtering of a first point cloud subset including the point cloud data of the first region from the point cloud data of the surrounding environment of the robot based on this preset intensity range during the identification process of the charging base station.

In one application scenario, special stickers may be affixed to the charging base station to achieve configuration of N first regions and N-1 second region(s). As an example and not a limitation, N first stickers and N-1 second sticker(s) may be affixed to the charging base station, with one second sticker placed between any two adjacent first stickers. The first sticker may be made from high-reflectivity materials, while the second sticker may be made from wave-absorbing materials. High-reflectivity materials enhance the reflection of signals, allowing the robot to more accurately obtain positional information of the charging base station, thereby improving the identification accuracy of the charging base station. Wave-absorbing materials are capable of absorbing surrounding radio waves and other electromagnetic signals, so as to reduce external interference and ensure that the robot is able to accurately receive and process point cloud data from the first region, thereby avoiding misjudgments and inaccuracies in positioning.

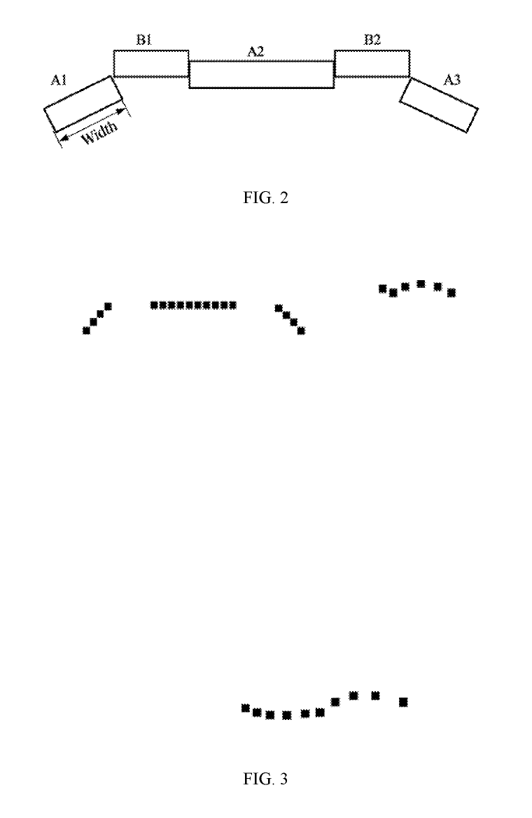

Considering the complexity of manufacturing such a structure with N first regions and N-1 second region(s), as well as labor and material costs, N may be set to 3. For example, as shown in FIG. 2, three first regions and two second regions are configured on the charging base station, with regions A1, A2, and A3 representing the first regions and regions B1 and B2 representing the second regions. Of course, it should be understood that N may also be set to other integers such as 2, 4, 5, etc., which is not limited in the present disclosure. For ease of understanding, this embodiment describes the case where N equals 3, but this does not constitute a limitation on the value of N.

At operation 102, points having intensity values within a preset intensity range are filtered from the point cloud data to obtain a first point cloud subset.

A minimum value of the preset intensity range is greater than the second intensity value, and a maximum value of the preset intensity range is the first intensity value. Therefore, based on the preset intensity range, high-reflectivity data from the surrounding environment may be filtered from the point cloud data, and the filtered high-reflectivity data constitutes the first point cloud subset. The filtered high-reflectivity data typically includes point cloud data from the first regions, thereby allowing for the exclusion of point cloud data that does not belong to high-reflectivity data. As shown in FIG. 3, which is an example diagram of the first point cloud subset. It is seen from FIG. 3 that, in addition to the high-reflectivity data from the three first regions of the charging base station, the first point cloud subset further includes high-reflectivity data from other materials in the surrounding environment. Therefore, after obtaining the first point cloud subset, further filtering of the first point cloud subset is required through subsequent operations.

In one embodiment, if there are no points in the point cloud data of the surrounding environment of the the robot that have intensity values within the preset intensity range, the robot may return to execute operation 101 and the subsequent operations after moving for a preset duration. The preset duration may be determined based on empirical values from practical scenarios, and the specific value of the preset duration is not limited in the present disclosure.

In one possible implementation, prior to executing operation 103, the method further includes: in response to a target point being present in the first point cloud subset, the target point is excluded from the first point cloud subset. The target point is defined as a point in the point cloud data whose left and right adjacent points have intensity values that are not within the preset intensity range.

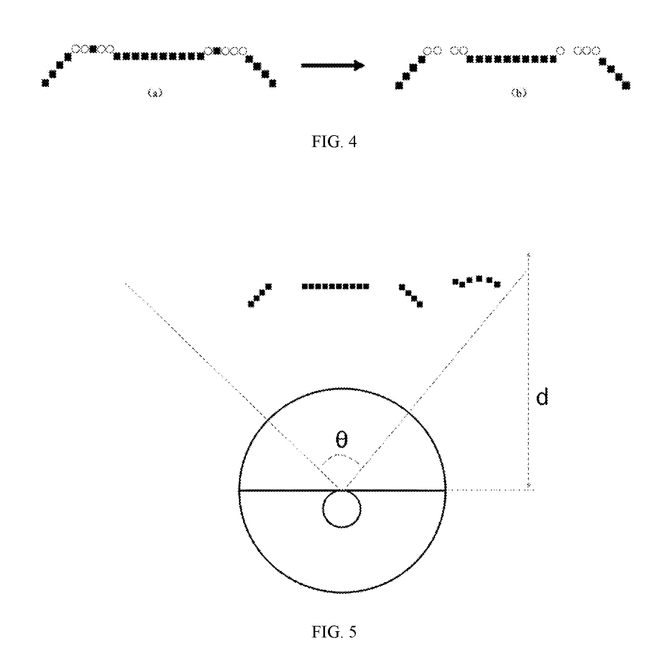

For the high-reflectivity data detected by the LiDAR, it may not necessarily represent the required valid data (i.e., point cloud data of the N first regions), such as noise points. In practical scenarios, the second region may also contain noise points with relatively high intensity values. Excluding these high-intensity noise points from the first point cloud subset enhances the accuracy of identifying the charging base station. As shown in FIG. 4, which is an example diagram of excluding the target point from the first point cloud subset, part (a) of FIG. 4 shows the first point cloud subset, where square blocks in the two second regions represent target points, and part (b) of FIG. 4 shows the first point cloud subset after excluding the target point. It should be understood that the circular blocks (i.e., points with intensity values not within the preset intensity range) in FIG. 4 are shown to facilitate the understanding that the intensity values of both the left and right adjacent points are not within the preset intensity range. In actual situations, the circular blocks in FIG. 4 have been excluded.

At operation 103, points having angles within a first preset angle range and distances within a first preset distance range are filtered from the first point cloud subset to obtain a second point cloud subset.

It should be understood that the points referred to in this embodiment are points within the point cloud data.

The angle of a point may refer to an angle of the point relative to a starting point. The distance of a point may refer to a distance between the point and the robot.

The LiDAR mounted on the sweeping robot typically rotates 360 degrees and has data from a plurality of points, e.g., 500 points. Among these 500 points, there is a starting point and an ending point. If an angle of the starting point is 0 degrees and an angle of the ending point is 360 degrees, then the 498 points between the starting and ending points each correspond to a respective angle, which represents the angles of those 498 points relative to the starting point.

During the process of aligning with the charging base station for charging, the robot needs to move with its charging electrodes orienting towards the charging base station, so as to make the charging electrodes of the robot align with charging electrodes of the charging base station after identifying the charging base station. Therefore, the first preset angle range and the first preset distance range are related to the position of the robot’s charging electrodes. If the charging electrodes of the robor are located at the front (i.e., the side with more sensors installed) of the robot, the first preset angle range may be set based on angles of the point cloud data in front of the robot, and the first preset distance range may be set based on distances of the point cloud data in front of the robot. Conversely, if the charging electrodes of the robot are located at the rear of the robot, the first preset angle range may be set based on angles of the point cloud data behind the robot, and the first preset distance range may be set based on distances of the point cloud data behind the robot.

Taking a sweeping robot that aligns with the charging base station at the rear for charging as an example, the robot is close to the charging base station during the alignment process, so it is more efficient to filter points within the first point cloud subset that are located within the first preset angle range and the first preset distance range behind the robot as valid data. As an example and not a limitation, the first preset angle range may be set from 60 degrees to 90 degrees, and the first preset distance range may be set from 0.2 meters to 0.4 meters.

FIG. 5 is an example diagram of the first preset angle range and the first preset distance range, the first preset angle range is represented by θ, and the first preset distance range is defined as being less than or equal to d.

During the process of aligning with the charging base station for charging, the robot is in close proximity to the charging base station. Therefore, to efficiently process the first point cloud subset, valid data (i.e., a second point cloud subset) that meets the requirements of the first preset angle range and the first preset distance range may be filtered from the first point cloud subset. Based on the second point cloud subset, the charging base station in the surrounding environment is accurately identified.

In one embodiment, if there are no points in the first point cloud subset that have angles within the first preset angle range and distances within the first preset distance range, the robot may return to execute operation 101 and the subsequent operations after moving for a preset duration.

At operation 104, a charging base station identification result is determined based on the second point cloud subset.

Since the points in the second point cloud subset are high-reflectivity data that are relatively close to the robot, they are more likely to meet the requirements for high-reflectivity data from the N first regions of the charging base station in real-world scenarios. Thus, the charging base station in the surrounding environment is able to be accurately identified based on the second point cloud subset.

In one possible implementation, the operation 104 may include: clustering points in the second point cloud subset based on a first neighborhood radius to obtain first clusters. The first neighborhood radius is less than a distance between two adjacent first regions.

If the number of first clusters is greater than or equal to N, first clusters with point numbers greater than or equal to a first point number threshold and less than or equal to a second point number threshold are filtered to obtain a third point cloud subset. The first point number threshold is determined based on a width of a first candidate region, and the second point number threshold is determined based on a width of a second candidate region. The first candidate region is a first region with a narrowest width among the N first regions, and the second candidate region is a first region with a widest width among the N first regions.

The charging base station identification result is determined based on the third point cloud subset.

The robot filters the point cloud data of the surrounding environment through operations 102 and 103 to obtain a preliminary second point cloud subset that may represent the charging base station and needs to be processed. To prevent the point cloud data from fluctuations or to avoid the second point cloud subset not covering the real charging base station, the first preset angle range and the first preset distance range are typically set to be relatively large. This may lead to the detection of false charging base stations with high-reflectivity materials in the surrounding environment (as shown in FIG. 5). To improve the accuracy of charging base station identification, clustering algorithms may be used to exclude these high-reflectivity regions of false charging base stations.

To avoid classifying two adjacent first regions into the same cluster, the distance between the two adjacent first regions should be considered when setting the first neighborhood radius, ensuring that the first neighborhood radius is less than the distance between the two adjacent first regions. Since a region include at least two points, and there is a second region between the two adjacent first regions which typically includes more than two points, the first neighborhood radius may be set based on a width corresponding to two adjacent points in the actual point cloud data.

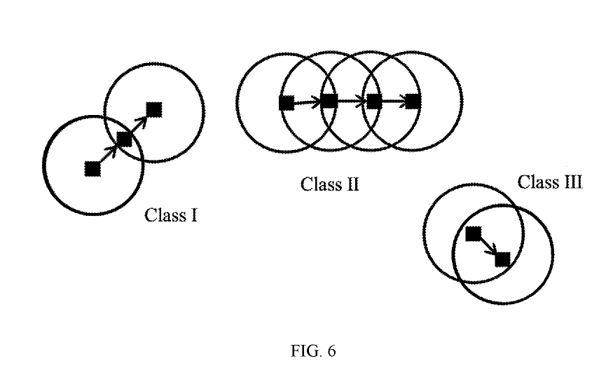

As an example and not a limitation, if the width corresponding to two points in the point cloud data is 1.5 centimeters, the first neighborhood radius may be set to 1.5 centimeters. FIG. 6 is a clustering example diagram including three clusters. The three clusters are represented as Class I, Class II, and Class III in FIG. 6.

To enhance the efficiency and accuracy of charging base station identification, when designing the N first regions and the N-1 second region(s) of the charging base station, the distances between all adjacent two first regions are defined to be the same, a width of a first region located in the middle of the N first regions is greater than widths of regions at other positions, and widths of the N-1 second regions are the same. As shown in FIG. 2, the widths of A1 and A3 are the same, while the width of A2 is greater than the widths of A1 and A3. The distances between A1 and A2 and between A2 and A3 are the same, and the widths of B1 and B2 are the same. Of course, it should be understood that the widths of the N first regions may also be different, the distances between all adjacent two first regions may vary, and the widths of the N-1 second regions may also differ. Based on this, the first neighborhood radius may be set to be less than a minimum value of the distances between all adjacent two first regions.

The first point number threshold may be a point number cooresponding to a width of a first candidate region or a point number that matches the width of the first candidate region. As shown in FIG. 5, the first point number threshold is set to 4. The second point number threshold may refer to a point number corresponding to a width of a second candidate region or a point number that matches the width of the second candidate region, as shown in FIG. 5, where the second point number threshold is set to 10.

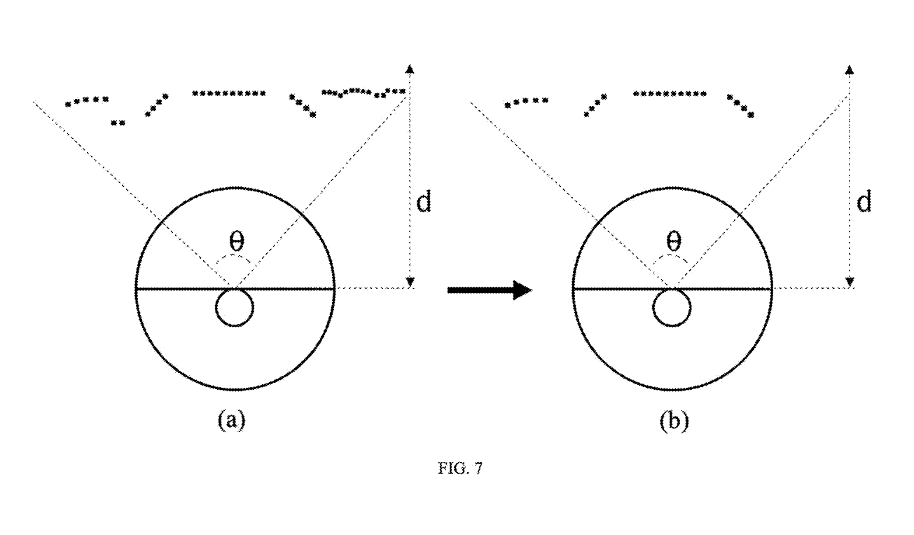

Given that the number of the first regions is N and the value of the first neighborhood radius is relatively small, the point cloud data of the first region may only exist in the second point cloud subset when the number of first clusters is at least N. Furthermore, since the N first regions of the charging base station have fixed widths, the first candidate region considers a maximum possible error that mat actually exist and a minimum number of high-reflectivity points that may be detected, and uses a smaller first neighborhood radius for clustering to obtain the first clusters. If a first cluster has a small point number, this first cluster may be generated from noise due to a small amount of high-reflectivity data or fluctuations in the data from the first region of the charging base station, and the first cluster with a small point number is excluded from the clustering.If a first cluster has a large point number, this first cluster may represent a larger high-reflectivity object present around the charging base station. The point number of this first cluster is then compared to the second point number threshold, and the first cluster with a large point number is excluded from the clustering. As shown in FIG. 7, part (a) of FIG. 7 includes clusters with smaller point numbers and clusters with larger point numbers, and part (b) of FIG. 7 shows the third point cloud subset obtained after excluding the clusters with samller and larger point numbers from part (a) of FIG. 7.

In one embodiment, if the number of first clusters is less than N, or if none of the N first clusters have point numbers greater than or equal to the first point number threshold and less than or equal to the second point number threshold, the robot may return to execute operation 101 and the subsequent operations after moving for a preset duration.

In one possible implementation, the determinining the charging base station identification result based on the third point cloud subset includes: clustering points in the third point cloud subset based on a second neighborhood radius to obtain at least one second cluster, where the second neighborhood radius is greater than the distance between the two adjacent first regions; filtering at least one second cluster with a point number greater than or equal to the second point number threshold and less than or equal to the third point number threshold, where the third point number threshold is determined based on a total width of the N first regions; and determining the charging base station identification result based on the filtered at least one second cluster.

The third point number threshold may be a point number corresponding to the total width of the N first regions or the point number that matches the total width of the N first regions. As shown in FIG. 2, a sum of the widths of A1, A2, and A3 represents the total width of these three first regions.

The filtered third point cloud subset typically includes valid data of the charging base station (i.e., charging base station data). Furthermore, clustering may be performed on the points in the third point cloud subset based on the second neighborhood radius to filter out the charging base station data that includes the N first regions. Since there is a certain distance d1 between two adjacent first regions of the charging base station, the second neighborhood radius for clustering should cover this distance d1 to ensure that the N first regions of the charging base station are classified as the same charging base station class. The point number of the charging base station class is then compared to the second point number threshold and the third point number threshold to ultimately obtain the second cluster that is highly likely to represent the charging base station data. FIG. 8 is an example diagram of the second cluster, where clusters composed of square blocks represent charging base station classes, and the cluster composed of circular blocks represents other obstacle classes.

In one embodiment, if none of the at least one second clusters have point numbers greater than or equal to the second point number threshold and less than or equal to the third point number threshold, the robot may return to execute operation 101 and the subsequent operations after moving for a preset duration.

In one possible implementation, the determining the charging base station identification result based on the filtered at least one second cluster includes: for any second cluster of the filtered at least one second cluster, clustering points in the second cluster based on a third neighborhood radius to obtain third clusters, where the third neighborhood radius is greater than the first neighborhood radius and less than or equal to the distance between the two adjacent first regions; and in response to a number of third clusters being N and point numbers of the N third clusters matching widths of the N first regions, determining the charging base station identification result based on the N third clusters.

The point numbers of the N third clusters matching the widths of the N first regions may refer to the point numbers of the N third clusters respectively matching the widths of corresponding first regions. As an example and not a limitation, there are three third clusters, where a point number of the left third cluster corresponds to the width of A1 in FIG. 2, a point number of the middle third cluster corresponds to the width of A2 in FIG. 2, and a point number of the right third cluster corresponds to the width of A3 in FIG. 2.

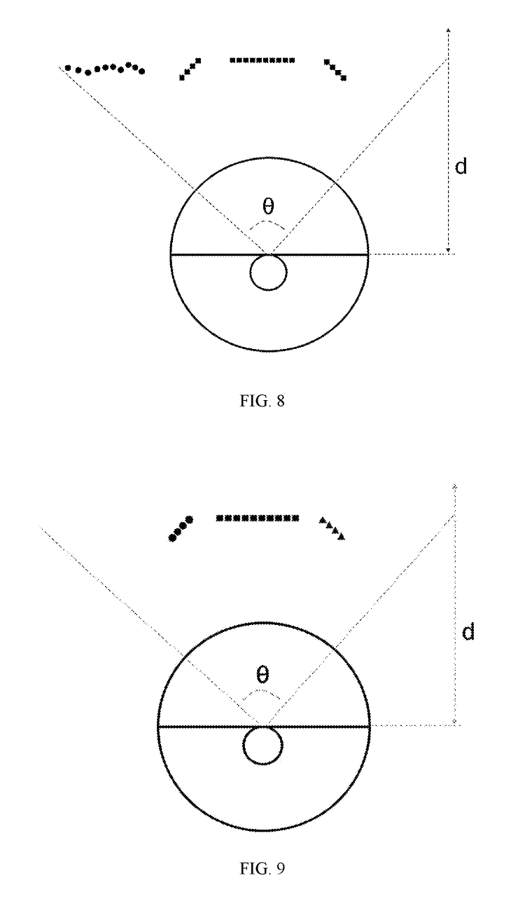

For any filtered second cluster, it may not meet the requirements of the N first regions of the charging base station. For example, the second cluster may represent an entire high-reflectivity region or an intermittent high-reflectivity region with more than N segments. Therefore, it is required to filter out the second clusters that do not meet the requirements of the N first regions of the charging base station and find second clusters that meet the requirements of the N first regions of the charging base station. Specifically, a third neighborhood radius is set based on the distance between the two adjacent first regions on the charging base station as a reference standard, and clustering is performed on each point in the second cluster based on the third neighborhood radiusto obtain third clusters, with the requirement that a point number of each third cluster matches the width of the corresponding first region on the charging base station. On this basis, the N first regions on the charging base station may be delineated from the points in the second clusters that meet the above requirements. FIG. 9 is an example diagram of three third clusters, where the three third clusters correspond to the three first regions on the charging base station. The circular blocks in FIG. 9 correspond to A1 in FIG. 2, the square blocks in FIG. 9 correspond to A2 in FIG. 2, and the triangular blocks in FIG. 9 correspond to A3 in FIG. 2.

In one embodiment, if the number of third clusters is not N or if the point numbers of the N third clusters do not match the widths of the N first regions, the robot may return to execute operation 101 and subsequent operations after moving for a preset time.

In one possible implementation, determining the charging base station identification result based on the N third clusters includes: for any two adjacent third clusters, acquiring average angles and average distances of the two adjacent third clusters, respectively; in response to an absolute value of a difference between the average angles of the two adjacent third clusters being within a second preset angle range and an absolute value of a difference between the average distances of the two adjacent third clusters being within a second preset distance range, determining each point in the N third clusters as point cloud data of the N first regions.

For the identified N third clusters, in order to ensure greater accuracy, i.e., to confirm that each point in these N third clusters is indeed point cloud data of the N first regions of the charging base station, any two adjacent third clusters may be selected from the N third clusters, and further identification of the N first regions may be performed for the N third clusters based on the differences between the average angles and average distances of the two adjacent third clusters.

For any third cluster, the robot may determine an average angle of the third cluster based on angles of the points in the third cluster, and determine an average distance of the third cluster based on distances of the points in the third cluster. The median of the angles of the points in the third cluster may also be determined as the average angle of the third cluster, and the median of the distances of the points in the third cluster may be determined as the average distance of the third cluster.

In the case where the distances between all adjacent two first regions on the charging base station are the same, the widths of the N first regions are the same when N is not 3, or the widths of the first regions on the left and right sides are the same when N is 3, absolute values of differences between average angles of different two adjacent first regions have relatively small differences, and absolute values of differences between average distances of different two adjacent first regions have relatively small small differences. Consequently, absolute values of the differences between average angles of the corresponding two adjacent third clusters also have relatively small differences, and absolute values of the differences between average distances of the corresponding two adjacent third clusters also have relatively small differences. Therefore, any pair of two adjacent third clusters may be selected from all adjacent two third clusters, and an absolute value of a difference between average angles of this pair of two adjacent third clusters may be compared with the second preset angle range, as well as an absolute value of a difference between average distances of this pair of two adjacent third clusters may be compared with the second preset distance range.

In the case where there are different distances between all adjacent two first regions on the charging base station, or where the widths of the N first regions are different when N is not 3, or where the widths of the first regions on the left and right sides are different when N is 3, each pair of two adjacent first regions among the N first regions may correspond to a respective second preset angle range and a second preset distance range. For each pair of two adjacent third clusters among all adjacent two third clusters, the absolute value of the difference between average angles of the pair of two adjacent third clusters may be compared with the second preset angle range of the corresponding two adjacent first regions, and the absolute value of the difference between average distances of the pair of two adjacent third clusters may be compared with the second preset distance range of the corresponding two adjacent first regions.

Optionally, the second preset angle range and the second preset distance range may be determined based on empirical values from practical scenarios. For example, the second preset angle range may be from 10 degrees to 15 degrees, and the second preset distance range may be from 1 centimeter to 2 centimeters.

As an example and not a limitation, in practical scenarios, positions of the first regions on the charging base station are known. By scanning each first region with the LiDAR, the angle and distance of point cloud data of each first regionare obtained. Based on the angle and distance of the point cloud data of each first region, the average angle and average distance of each first region are determined. Based on the average angles and average distances of any two adjacent first regions, the absolute value of the difference between average angles and the absolute value of the difference between average distances are obtained. Based on the absolute value of the difference between average angles of the two adjacent first regions, the second preset angle range corresponding to the two adjacent first regions is determined (e.g., a maximum value of the second preset angle range may be determined by adding the absolute value of the difference between average angles of the two adjacent first regions to a first angle, and a minimum value of the second preset angle range may be determined by subtracting the absolute value of the difference between average angles of the two adjacent first regions from a second angle, where the first angle and the second angle may be pre-set empirical values. It should be understood that the second preset angle range may also be determined in other ways, which is not limited in the present disclosure). Based on the absolute value of the difference between average distances of the two adjacent first regions, the second preset distance range corresponding to the two adjacent first regions is determined (e.g., a maximum value of the second preset distance range may be determined by adding the absolute value of the difference between average distances of the two adjacent first regions to a first distance, and a minimum value of the second preset distance range may be determined by subtracting the absolute value of the difference between average distances of the two adjacent first regions from a second distance, where the first distance and the second distance may also be pre-set empirical values, and it should understood that the second preset distance range may be determined in other ways, which is not limited in the present disclosure).

In one embodiment, if the absolute value of the difference between average angles of the two adjacent third clusters is not within the second preset angle range, or if the absolute value of the difference between average distances of the two adjacent third clusters is not within the second preset distance range, the robot may return to execute operation 101 and subsequent operations after moving for a preset duration.

Once the robot obtains the point cloud data of the N first regions on the charging base station, it is able to achieve the positioning of the charging base station, thereby identifying the charging base station in the surrounding environment.

In this embodiment, the robot utilizes an onboard LiDAR to identify the charging base station. The point cloud data obtained from LiDAR scanning is the data data capable of obtaining intensity values of objects. The LiDAR is not only employed for the robot’s mapping and localization but is also applied in the identification of the charging base station. Furthermore, the high-reflectivity data identified by the LiDAR in this embodiment allows for the exclusion of invalid data, while valid data is clustered to ultimately obtain the point cloud data that meets the design requirements of the charging base station so as to identify the charging base station, thereby effectively utilizing the point cloud data from the LiDAR and impeoving the accuracy of identifying the charging base station.

In the embodiments of the present disclosure, the charging base station is configured with N first regions and N-1 second region(s), where the first intensity value corresponding to the first region is greater than the second intensity value corresponding to the second region. Additionally, a second region is positioned between each pair of two adjacent first regions. Based on this, a intensity range (i.e., a preset intensity range) is predetermined based on the first intensity value and the second intensity value. The point cloud data of a target region is then filtered based on the preset intensity range to obtain a first point cloud subset. Further filtering is performed on the first point cloud subset to filter points having angles within the first preset angle range and distances within the first preset distance range to obtain a second point cloud subset. The charging base station identification result is then determined based on the second point cloud subset, thereby effectively reducing the likelihood of misidentification and improving the accuracy of identifying the charging base station.

It should be understood that the size of sequence numbers of the operations described in the above embodiments does not imply a specific order of execution. The execution order of each process should be determined by its functionality and inherent logic, which should not impose any limitations on the implementation process of the embodiments of the present disclosure.

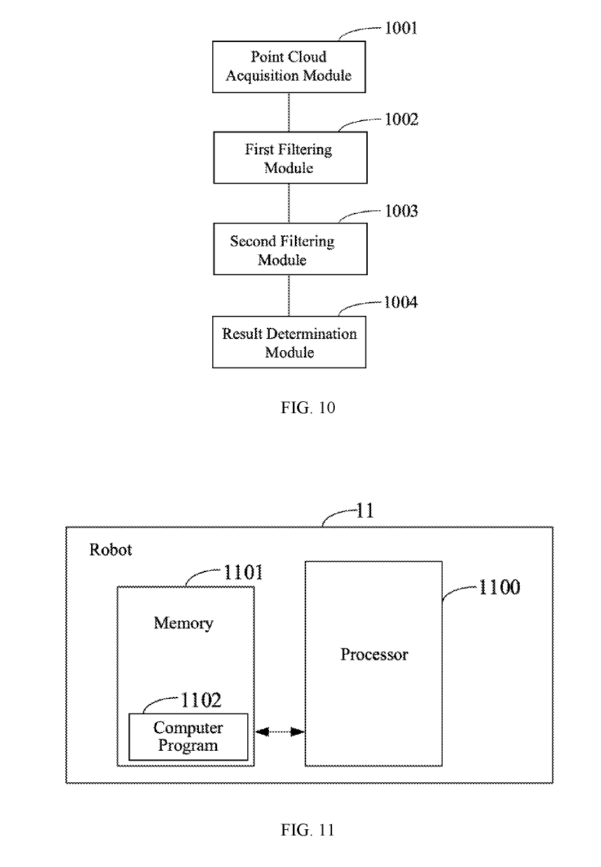

Corresponding to the method for identifying the charging base station described in the above embodiments, FIG. 10 illustrates a schematic structural diagram of an apparatus for identifying a charging base station according to an embodiment of the present disclosure. For clarity, only the parts relevant to the embodiments of the present disclosure are shown.

Referring to FIG. 10, the apparatus includes: a point cloud acquisition module 1001, configured to acquire point cloud data of a surrounding environment; a first filtering module 1002, configured to filter, from the point cloud data, points having intensity values within a preset intensity range to obtain a first point cloud subset; where a maximum value of the preset intensity range is greater than or equal to a first intensity value, and a minimum value of the preset intensity range is greater than a second intensity value; where the first intensity value corresponds to first regions, and the second intensity value corresponds to at least one second region; where the first regions and the at least one second region are different regions provided on the charging base station, a number of the first regions is N, a number of the at least one second region is N-1, and N is an integer greater than 1; and where each of the at least one second region is provided between two adjacent first regions of the first regions on the charging base station; a second filtering module 1003, configured to filter, from the first point cloud subset, points having angles within a first preset angle range and distances within a first preset distance range to obtain a second point cloud subset; and a result determination module 1004, configured to determine a charging base station identification result based on the second point cloud subset.

Optionally, the result determination module 1004 includes: a clustering submodule, configured to cluster points in the second point cloud subset based on a first neighborhood radius to obtain first clusters, where the first neighborhood radius is less than a distance between the two adjacent first regions; a filtering submodule, configured to: in response to a number of the first clusters being greater than or equal to N, filter first clusters with point numbers greater than or equal to a first point number threshold and less than or equal to a second point number threshold to obtain a third point cloud subset; where the first point number threshold is determined based on a width of a first candidate region, the second point number threshold is determined based on a width of a second candidate region, the first candidate region is a first region with a narrowest width among the N first regions, and the second candidate region is a first region with a widest width among the N first regions; and a result determination submodule, configured to determine the charging base station identification result based on the third point cloud subset.

Optionally, the result determination submodule includes: a clustering unit, configured to cluster points in the third point cloud subset based on a second neighborhood radius to obtain at least one second cluster, where the second neighborhood radius is greater than the distance between the two adjacent first regions; a filtering unit, configured to filter at least one second cluster with a point number greater than or equal to the second point number threshold and less than or equal to a third point number threshold, where the third point number threshold is determined based on a total width of the N first regions; and a determination unit, configured to determine the charging base station identification result based on the filtered at least one second cluster.

Optionally, the determination unit includes: a clustering subunit, configured to: for any second cluster of the filtered at least one second cluster, cluster points in the second cluster based on a third neighborhood radius to obtain third clusters, where the third neighborhood radius is greater than the first neighborhood radius and less than or equal to the distance between the two adjacent first regions; and a determination subunit, configured to: in response to a number of the third clusters being N and point numbers of the N third clusters matching widths of the N first regions, determine the charging base station identification result based on the N third clusters.

Optionally, the determination subunit is further configured to: for any two adjacent third clusters, acquire average angles and average distances of the two adjacent third clusters, respectively; and in response to an absolute value of a difference between the average angles of the two adjacent third clusters being within a second preset angle range and an absolute value of a difference between the average distances of the two adjacent third clusters being within a second preset distance range, determine each point in the N third clusters as point cloud data of the N first regions.

Optionally, the apparatus further includes: an exclusion module, configured to: in response to a target point being present in the first point cloud subset, exclude the target point from the first point cloud subset, where the target point is a point in the point cloud data whose left and right adjacent points have intensity values that are not within the preset intensity range.

Optionally, the point cloud acquisition module 1001 is further configured to acquire the point cloud data of the surrounding environment in a process of aligning with the charging base station for charging.

It should be noted that the information interaction and execution processes between the aforementioned apparatuses/units are based on the same concept as the method embodiments of the present disclosure. Therefore, the specific functions and technical effects brought about are detailed in the method embodiments and are not reiterated here.

FIG. 11 is a schematic structural diagram of a robot according to an embodiment of the present disclosure. As shown in FIG. 11, the robot 11 of the embodiment includes: at least one processor 1100 (only one is shown in FIG. 11), a memory 1101, and a computer program 1102 stored in the memory 1101 and executable on the at least one processor 1100. The processor 1100 executes the computer program 1102 to implement the operations in any of the method embodiments described above.

The robot includes, but is not limited to, the processor 1100, and the memory 1101. Those skilled in the art should understand that FIG. 11 is merely an example of the robot 11 and does not limit the robot 11. The robot may include more or fewer components than those illustrated, or combinations of certain components, or different components, such as input/output devices, network access devices, etc.

The processor 1100 may be a central processing unit (CPU), or may be other general-purpose processors, digital signal processors (DSP), application specific integrated circuits (ASIC), field-programmable gate arrays (FPGA) or other programmable logic devices, discrete gates or transistor logic devices, or discrete hardware components, etc. The general-purpose processor may be a microprocessor or any conventional processor.

In some embodiments, the memory 1101 may be an internal storage unit of the robot 11, such as a hard disk or memory of the robot 11. In other embodiments, the memory 1101 may also be an external storage device of the robot 11, such as a plug-in hard drive, smart media card (SMC), secure digital (SD) card, flash card, etc. equipped on the robot 11. Furthermore, the memory 1101 may include both the internal storage unit of the robot 11 and the external storage device of the robot 11. The memory 1101 is configured to store an operating system, application programs, boot loaders, data, and other programs, such as program codes of the computer program. The memory 1101 may further be configured to temporarily store data that has been output or is to be output.

Those skilled in the art may clearly understand that, for the sake of convenience and brevity in description, the division of the above functional units and modules is merely illustrative. In practical applications, the above functions may be allocated to and accomplished by different functional units or modules as needed. That is, an internal structure of the apparatus may be divided into different functional units or modules to accomplish all or part of the functions described above. The functional units and modules in the embodiments may be integrated into a single processing unit, or each unit may exist physically independently, or two or more units may be integrated into one unit. The integrated units may be realized in the form of hardware or in the form of software functional units. Furthermore, specific names of the functional units and modules are only for the purpose of facilitating mutual distinction and do not limit the protection scope of the present disclosure. The specific working processes of the units and modules in the above system may refer to the corresponding processes in the previously mentioned method embodiments and are not reiterated here.

The integrated unit of the robot may be stored in a computer-readable storage medium if implemented in the form of a software functional unit and sold or used as a standalone product. Based on such understanding, the implementation of all or part of the processes in the above method embodiments may be accomplished by instructing the relevant hardware through a computer program. The computer program is able to be stored in a computer-readable storage medium which, when executed by a processor, implements the operations of the various method embodiments described above. The computer program includes a computer program code, which may be in the form of source code, object code, executable files, or certain intermediate forms. The computer-readable storage medium may include at least: any entity or device capable of carrying the computer program code to a device/robot, recording media, computer memory, read-only memory (ROM), random access memory (RAM), electrical carrier signals, telecommunication signals, and software distribution media, such as USB drives, portable hard drives, magnetic disks, or optical discs. In some jurisdictions, according to legislation and patent practices, the computer-readable medium cannot be carrier signals or telecommunication signals.

In the above embodiments, the descriptions of each embodiment have their own focus. Parts that are not detailed or recorded in one embodiment can refer to the relevant descriptions of other embodiments.

Those skilled in the art should recognize that the units and algorithm operations described in the examples disclosed herein can be implemented in electronic hardware, or in a combination of computer software and electronic hardware. Whether these functions are executed in hardware or software depends on the specific application of the technical solution and design constraints. Those skilled in the art may use different methods to implement the described functions for each specific application. However, such implementations should not be considered beyond the scope of the present disclosure.

In the embodiments provided in the present disclosure, it should be understood that the disclosed apparatuses/robots and methods may be implemented in other ways. For example, the apparatuses/robots described above are merely illustrative, e.g., the division of modules or units is only one logical functional division. In actual implementation, there may be other ways of division, such as a plurality of units or components being combined or integrated into another system, or some features being omitted or not executed. Additionally, the coupling, direct coupling, or communication connections shown or discussed may be through certain interfaces, and the indirect coupling or communication connections between devices or units may be electrical, mechanical, or in other forms.

The units described as separate components may or may not be physically separated. The components displayed as units may or may not be physical units, i.e., may be located in one place or distributed across a plurality of network units. Portions or all of the units may be selected as needed to achieve the objectives of the embodiments of the present disclosure.

The above embodiments are intended to illustrate but not to limit the technical solutions of the present disclosure. Although the present disclosure has been described in detail with reference to the above embodiments, those skilled in the art should understand that modifications can still be made to the technical solutions described in the above embodiments, or equivalent substitutions can be made for some of the technical features therein. Such modifications or substitutions do not depart from the spirit and scope of the technical solutions of the embodiments of the present disclosure and should be included within the protection scope of the present disclosure.

What is claimed is:

1. A method for identifying a charging base station, comprising:
acquiring point cloud data of a surrounding environment;
filtering, from the point cloud data, points having intensity values within a preset intensity range to obtain a first point cloud subset; wherein a maximum value of the preset intensity range is greater than or equal to a first intensity value, and a minimum value of the preset intensity range is greater than a second intensity value; wherein the first intensity value corresponds to first regions, and the second intensity value corresponds to at least one second region; wherein the first regions and the at least one second region are different regions provided on the charging base station, a number of the first regions is N, a number of the at least one second region is N-1, and N is an integer greater than 1; and wherein each of the at least one second region is provided between two adjacent first regions of the first regions on the charging base station;
filtering, from the first point cloud subset, points having angles within a first preset angle range and distances within a first preset distance range to obtain a second point cloud subset; and
determining a charging base station identification result based on the second point cloud subset.

2. The method according to claim 1, wherein determining the charging base station identification result based on the second point cloud subset includes:
clustering points in the second point cloud subset based on a first neighborhood radius to obtain first clusters, wherein the first neighborhood radius is less than a distance between the two adjacent first regions;
in response to a number of the first clusters being greater than or equal to N, filtering first clusters with point numbers greater than or equal to a first point number threshold and less than or equal to a second point number threshold to obtain a third point cloud subset; wherein the first point number threshold is determined based on a width of a first candidate region, the second point number threshold is determined based on a width of a second candidate region, the first candidate region is a first region with a narrowest width among the N first regions, and the second candidate region is a first region with a widest width among the N first regions; and
determining the charging base station identification result based on the third point cloud subset.

3. The method according to claim 2, wherein determining the charging base station identification result based on the third point cloud subset includes:
clustering points in the third point cloud subset based on a second neighborhood radius to obtain at least one second cluster, wherein the second neighborhood radius is greater than the distance between the two adjacent first regions;
filtering at least one second cluster with a point number greater than or equal to the second point number threshold and less than or equal to a third point number threshold, wherein the third point number threshold is determined based on a total width of the N first regions; and
determining the charging base station identification result based on the filtered at least one second cluster.

4. The method according to claim 3, wherein determining the charging base station identification result based on the filtered at least one second cluster includes:
for any second cluster of the filtered at least one second cluster, clustering points in the second cluster based on a third neighborhood radius to obtain third clusters, wherein the third neighborhood radius is greater than the first neighborhood radius and less than or equal to the distance between the two adjacent first regions; and
in response to a number of the third clusters being N and point numbers of the N third clusters matching widths of the N first regions, determining the charging base station identification result based on the N third clusters.

5. The method according to claim 4, wherein determining the charging base station identification result based on the N third clusters includes:
for any two adjacent third clusters, acquiring average angles and average distances of the two adjacent third clusters, respectively; and
in response to an absolute value of a difference between the average angles of the two adjacent third clusters being within a second preset angle range and an absolute value of a difference between the average distances of the two adjacent third clusters being within a second preset distance range, determining each point in the N third clusters as point cloud data of the N first regions.

6. The method according to claim 1, wherein before filtering, from the first point cloud subset, the points having the angles within the first preset angle range and the distances within the first preset distance range to obtain the second point cloud subset, the method further includes:
in response to a target point being present in the first point cloud subset, excluding the target point from the first point cloud subset, wherein the target point is a point in the point cloud data whose left and right adjacent points have intensity values that are not within the preset intensity range.

7. The method according to claim 1, wherein acquiring the point cloud data of the surrounding environment includes:
acquiring the point cloud data of the surrounding environment in a process of aligning with the charging base station for charging.

8. A robot, comprising a memory, a processor, and a computer program stored in the memory and executable on the processor, wherein the robot performs, when the processor executes the computer program, a method for identifying a charging base station; wherein the method includes:
acquiring point cloud data of a surrounding environment;
filtering, from the point cloud data, points having intensity values within a preset intensity range to obtain a first point cloud subset; wherein a maximum value of the preset intensity range is greater than or equal to a first intensity value, and a minimum value of the preset intensity range is greater than a second intensity value; wherein the first intensity value corresponds to first regions, and the second intensity value corresponds to at least one second region; wherein the first regions and the at least one second region are different regions provided on the charging base station, a number of the first regions is N, a number of the at least one second region is N-1, and N is an integer greater than 1; and wherein each of the at least one second region is provided between two adjacent first regions of the first regions on the charging base station;
filtering, from the first point cloud subset, points having angles within a first preset angle range and distances within a first preset distance range to obtain a second point cloud subset; and
determining a charging base station identification result based on the second point cloud subset.

9. The robot according to claim 8, wherein determining the charging base station identification result based on the second point cloud subset includes:
clustering points in the second point cloud subset based on a first neighborhood radius to obtain first clusters, wherein the first neighborhood radius is less than a distance between the two adjacent first regions;
in response to a number of the first clusters being greater than or equal to N, filtering first clusters with point numbers greater than or equal to a first point number threshold and less than or equal to a second point number threshold to obtain a third point cloud subset; wherein the first point number threshold is determined based on a width of a first candidate region, the second point number threshold is determined based on a width of a second candidate region, the first candidate region is a first region with a narrowest width among the N first regions, and the second candidate region is a first region with a widest width among the N first regions; and
determining the charging base station identification result based on the third point cloud subset.

10. The robot according to claim 9, wherein determining the charging base station identification result based on the third point cloud subset includes:
clustering points in the third point cloud subset based on a second neighborhood radius to obtain at least one second cluster, wherein the second neighborhood radius is greater than the distance between the two adjacent first regions;
filtering at least one second cluster with a point number greater than or equal to the second point number threshold and less than or equal to a third point number threshold, wherein the third point number threshold is determined based on a total width of the N first regions; and
determining the charging base station identification result based on the filtered at least one second cluster.

11. The robot according to claim 10, wherein determining the charging base station identification result based on the filtered at least one second cluster includes:
for any second cluster of the filtered at least one second cluster, clustering points in the second cluster based on a third neighborhood radius to obtain third clusters, wherein the third neighborhood radius is greater than the first neighborhood radius and less than or equal to the distance between the two adjacent first regions; and
in response to a number of the third clusters being N and point numbers of the N third clusters matching widths of the N first regions, determining the charging base station identification result based on the N third clusters.

12. The robot according to claim 11, wherein determining the charging base station identification result based on the N third clusters includes:
for any two adjacent third clusters, acquiring average angles and average distances of the two adjacent third clusters, respectively; and
in response to an absolute value of a difference between the average angles of the two adjacent third clusters being within a second preset angle range and an absolute value of a difference between the average distances of the two adjacent third clusters being within a second preset distance range, determining each point in the N third clusters as point cloud data of the N first regions.

13. The robot according to claim 8, wherein before filtering, from the first point cloud subset, the points having the angles within the first preset angle range and the distances within the first preset distance range to obtain the second point cloud subset, the method further includes:
in response to a target point being present in the first point cloud subset, excluding the target point from the first point cloud subset, wherein the target point is a point in the point cloud data whose left and right adjacent points have intensity values that are not within the preset intensity range.

14. The robot according to claim 8, wherein acquiring the point cloud data of the surrounding environment includes:
acquiring the point cloud data of the surrounding environment in a process of aligning with the charging base station for charging.

15. A computer program product comprising a computer program that, when executed, implements a method for identifying a charging base station; wherein the method includes:
acquiring point cloud data of a surrounding environment;
filtering, from the point cloud data, points having intensity values within a preset intensity range to obtain a first point cloud subset; wherein a maximum value of the preset intensity range is greater than or equal to a first intensity value, and a minimum value of the preset intensity range is greater than a second intensity value; wherein the first intensity value corresponds to first regions, and the second intensity value corresponds to at least one second region; wherein the first regions and the at least one second region are different regions provided on the charging base station, a number of the first regions is N, a number of the at least one second region is N-1, and N is an integer greater than 1; and wherein each of the at least one second region is provided between two adjacent first regions of the first regions on the charging base station;
filtering, from the first point cloud subset, points having angles within a first preset angle range and distances within a first preset distance range to obtain a second point cloud subset; and
determining a charging base station identification result based on the second point cloud subset.

16. The computer program product according to claim 15, wherein determining the charging base station identification result based on the second point cloud subset includes:
clustering points in the second point cloud subset based on a first neighborhood radius to obtain first clusters, wherein the first neighborhood radius is less than a distance between the two adjacent first regions;
in response to a number of the first clusters being greater than or equal to N, filtering first clusters with point numbers greater than or equal to a first point number threshold and less than or equal to a second point number threshold to obtain a third point cloud subset; wherein the first point number threshold is determined based on a width of a first candidate region, the second point number threshold is determined based on a width of a second candidate region, the first candidate region is a first region with a narrowest width among the N first regions, and the second candidate region is a first region with a widest width among the N first regions; and
determining the charging base station identification result based on the third point cloud subset.

17. The computer program product according to claim 16, wherein determining the charging base station identification result based on the third point cloud subset includes:
clustering points in the third point cloud subset based on a second neighborhood radius to obtain at least one second cluster, wherein the second neighborhood radius is greater than the distance between the two adjacent first regions;
filtering at least one second cluster with a point number greater than or equal to the second point number threshold and less than or equal to a third point number threshold, wherein the third point number threshold is determined based on a total width of the N first regions; and
determining the charging base station identification result based on the filtered at least one second cluster.

18. The computer program product according to claim 17, wherein determining the charging base station identification result based on the filtered at least one second cluster includes:
for any second cluster of the filtered at least one second cluster, clustering points in the second cluster based on a third neighborhood radius to obtain third clusters, wherein the third neighborhood radius is greater than the first neighborhood radius and less than or equal to the distance between the two adjacent first regions; and
in response to a number of the third clusters being N and point numbers of the N third clusters matching widths of the N first regions, determining the charging base station identification result based on the N third clusters.

19. The computer program product according to claim 18, wherein determining the charging base station identification result based on the N third clusters includes:
for any two adjacent third clusters, acquiring average angles and average distances of the two adjacent third clusters, respectively; and
in response to an absolute value of a difference between the average angles of the two adjacent third clusters being within a second preset angle range and an absolute value of a difference between the average distances of the two adjacent third clusters being within a second preset distance range, determining each point in the N third clusters as point cloud data of the N first regions.

20. The computer program product according to claim 15, wherein before filtering, from the first point cloud subset, the points having the angles within the first preset angle range and the distances within the first preset distance range to obtain the second point cloud subset, the method further includes:
in response to a target point being present in the first point cloud subset, excluding the target point from the first point cloud subset, wherein the target point is a point in the point cloud data whose left and right adjacent points have intensity values that are not within the preset intensity range.
